(19) United States
(12) Patent Application Publication
(10) Pub. No.: US 2012/0320312 A1
(43) Pub. Date: Dec. 20, 2012

(54) EXTENDABLE DISPLAY DEVICE

(75) Inventors: Ming-Huan Yang, Taichung City (TW); Wen-Chun Chen, Taipei City (TW); Chen-Chu Tsai, Taichung City (TW)

(73) Assignee: INDUSTRIAL TECHNOLOGY RESEARCH INSTITUTE, Hsinchu (TW)

(21) Appl. No.: 13/348,610

(22) Filed: Jan. 11, 2012

(30) Foreign Application Priority Data
Jun. 14, 2011 (TW) 100120728
Dec. 23, 2011 (TW) 100148318

(51) Int. Cl. G02F 1/1334; G02F 1/167

(52) U.S. Cl. 349/89; 359/296

(57) ABSTRACT

An extendable display device including an extendable substrate, and microcapsule display film. The microcapsule display film is located on the extendable substrate. The microcapsule display film includes a microcapsule display material and a plasticizer.

### CROSS-REFERENCE TO RELATED APPLICATION

This application claims the priority benefit of Taiwan application serial no. 100120728, filed on Jun. 14, 2011 and Taiwan application serial no. 100148318, filed on Dec. 23, 2011. The entirety of the above-mentioned patent applications is hereby incorporated by reference herein and made a part of this specification.

### BACKGROUND OF THE DISCLOSURE

1. Technical Field

The disclosure relates to a display and more particularly relates to an extendable display device.

2. Background

Conventional flexible display technology mostly adopts plastic plates as substrates and used as scrolls. This technology is often applied in e-books, information billboards, portable electronic products, or so on. The new display application in the future is not limited to a single curved surface, but can also be developed in complicated curved surfaces or shapes, or extendable panel technology. However, the most direct issue is the extendibility of the display medium.

Microcapsule displays have advantages of high brightness, high contrast, energy saving, memory capability, wide viewing angle, and no flickering. Most notably, microcapsule displays are bistable which means panels of microcapsule displays can display images persistently when the power is switched off. The microcapsule displays can thus be energy efficient. Microcapsule displays are advantageous as the structures thereof can be panels of single substrates and the manufacturing process thereof can include a plurality of wet coating processes. Moreover, microcapsule display films contain flexible coating support materials such as gelatin and the like for microcapsule display films obtain some flexibility and superior coating ability. Nevertheless, the property aforementioned fails to avoid fractures caused by tension or bending of complicated curved surfaces or extendable panels; this is mainly due to the insufficient flexibility of microcapsule display films.

### SUMMARY

An extendable display device including an extendable substrate and a microcapsule display film is introduced herein. The microcapsule display film is disposed on the extendable substrate. The microcapsule display film includes a plasticizer and a microcapsule display material.

Several exemplary embodiments accompanied with figures are described in detail below to further describe the disclosure in details.

### BRIEF DESCRIPTION OF THE DRAWINGS

The accompanying drawings are included to provide further understanding, and are incorporated in and constitute a part of this specification. The drawings illustrate exemplary embodiments and, together with the description, serve to explain the principles of the disclosure.

FIG. 1 is a schematic cross-sectional diagram of a microcapsule display according to an exemplary embodiment.

FIG. 2 is a schematic cross-sectional diagram of a microcapsule display according to another exemplary embodiment.

FIG. 3 is a schematic cross-sectional diagram of a microcapsule display according to another exemplary embodiment.

FIG. 4 shows photos of extendable films formed in examples 1-6.

FIG. 5 shows a photo of an extendable film formed in comparative example 1.

FIG. 6 shows photos of front sides and back sides of extendable films formed in examples 7-9.

### DETAILED DESCRIPTION OF DISCLOSED EMBODIMENTS

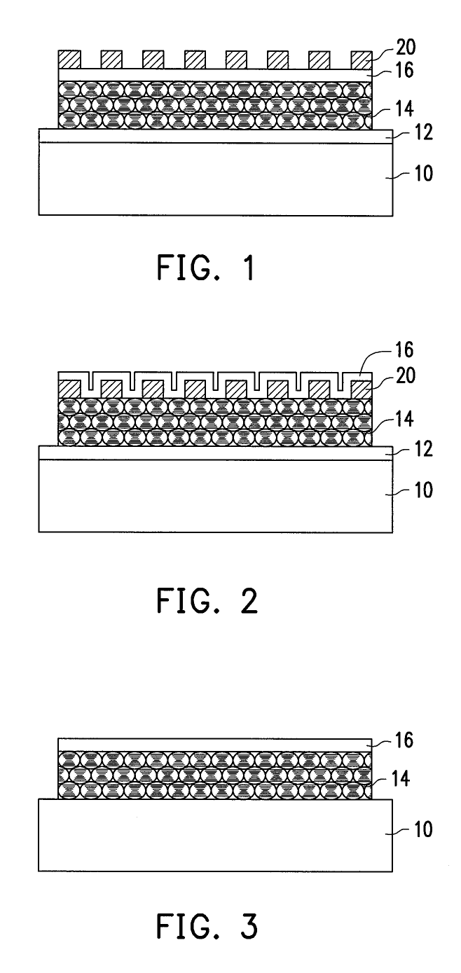

FIG. 1 and FIG. 2 are each a schematic cross-sectional diagram of a microcapsule display according to an exemplary embodiment. Referring to FIGS. 1 and 2, an extendable display device of the present exemplary embodiment is, for example, a microcapsule cholesteric liquid crystal display and includes a substrate 10, a first electrode layer 12, a microcapsule display film 14, an absorption layer 16, and a second electrode layer 20.

The substrate 10 is configured to bear devices and films of the display and can be an extendable substrate. In one exemplary embodiment, the substrate 10 is an extendable substrate, for example, a thermoplastic polymer substrate or an elastic polymer substrate. When the substrate 10 is an extendable substrate, the display can be manufactured by a roll-to-roll process. In addition, in an exemplary embodiment, a back side of the substrate 10 is a display side of the display and the substrate 10 is thus a light transmissive transparent substrate and, preferably, a transparent plastic substrate made by, for instance, polyethylene terephthalate (PET), polystyrene (PS), polyimide (PI), polypropylene (PP), Polyethylene (PE), or other plastic materials.

The first electrode layer 12 is disposed on the substrate 10. The first electrode layer 12 is a flexible transparent electrode. The first electrode layer 12 is an unpatterned electrode layer or a patterned electrode layer. In the present exemplary embodiment, a material of the first electrode layer 12 includes a transparent conductive polymer, a conductive nanotube, an extendable transparent metal mesh, or a transparent conductive material, or a combination thereof. The transparent conductive polymer is poly(3,4-ethylenedioxythiophene) (PEDOT), polyaniline (PANI), polypyrrole (PPY), or a combination thereof. The conductive nanotube is a carbon nanotube (CNT), a silver nanowire, a gold nanowire, a copper nanowire, or an alloy nanowire. The extendable transparent metal mesh is manufactured with copper, silver, or gold, for instance. The transparent conductive material is a transparent conductive material such as graphene and so on. A method of forming the first electrode layer 12 is a wet coating method, a printing method, a thermal pressing method, an electro deposition method, or a chemical deposition method, or a combination thereof.

The microcapsule display film 14 is disposed on the first electrode layer 12. The microcapsule display film 14 is a microcapsuled cholesteric liquid crystal layer or an electrophoretic microparticle layer. In other words, the microcapsule display film 14 has a plurality of microcapsule structures (or capsule structures) and each of the microcapsule structures encapsulate a microcapsule display material. The microcapsule display material includes a cholesteric liquid crystal or an electrophoretic microparticle. According to an exemplary embodiment of the disclosure, the microcapsule display film 14 includes a microcapsule cholesteric liquid crystal material (microcapsule cholesteric liquid crystal molecules), a plasticizer, and a binder. According to another exemplary embodiment of the disclosure, the microcapsule display film 14 includes an electrophoretic microparticle material, a plasticizer, and a binder.

The plasticizer has high absorbency or is capable of swelling between cholesteric liquid crystal molecules or electrophoretic microparticles. The plasticizer has a hydrophilic group, for example, and is an organic compound or a polymer having a plurality of hydroxyl groups, for example. The organic compound or the polymer having hydroxyl groups includes polyhydric alcohol, a derivative of polyhydric alcohol, polyol, or a combination thereof. In one exemplary embodiment, a molecular weight (Mw) of polyhydric alcohol or a derivative of polyhydric alcohol ranges from 90 to 10000. In another exemplary embodiment, an Mw of polyhydric alcohol or a derivative of polyhydric alcohol ranges from 90 to 1500. In another exemplary embodiment, an Mw of polyhydric alcohol or a derivative of polyhydric alcohol ranges from 90 to 200. Polyhydric alcohol is a linear polyhydric alcohol or a branched polyhydric alcohol, and preferably, a linear polyhydric alcohol. The linear polyhydric alcohol includes sorbitol, xylitol, fructose, amylose, maltitol, mannitol, erythritol or a combination thereof. A carbon number of polyol ranges from 2 to 8. A hydroxyl/carbon ratio in polyol ranges from 0.25 to 2, for example. Polyol is, for instance, ethylene glycol, propylene glycol, glycerin, butylene glycol, butanetriol, polyethylene glycol or a combination of structural isomers thereof. A content of the plasticizer in the microcapsuled cholesteric liquid crystal layer correlates with a content of hydrophilic groups (i.e. hydroxyl groups) in the plasticizer. Usually, the higher the content of hydrophilic groups (i.e. hydroxyl groups) in the plasticizer, the lower the content of the plasticizer is required in the microcapsuled cholesteric liquid crystal layer. Conversely, the lower the content of hydrophilic groups (i.e. hydroxyl groups) in the plasticizer, the higher the content of the plasticizer is required in the microcapsuled cholesteric liquid crystal layer. In one exemplary embodiment, a content of plasticizer in the microcapsuled cholesteric liquid crystal layer ranges from 10 wt % to 60 wt % (the sum of weights of the microcapsuled cholesteric liquid crystal material and the binder is 100%).

The binder includes polyvinylalcohol, animal glue, vegetable gum, microbial gum, or a combination thereof. The animal glue is, for example, gelatin, bone glue, skin glue, or fish maw glue. The vegetable gum is, arga, arabic gum, beam gum, tara gum, or karaya gum, for instance. The microbial gum is, for example, xanthan gum, gellan gum, or curdlan gum. In the microcapsule display film 14, a content of the binder ranges from 10 wt % to 50 wt % (the sum of weights of the microcapsule display material and the binder in the microcapsule display film 14 is 100%). A method of forming the microcapsule display film 14 can be any known methods for microcapsulating display materials and encapsulating display materials. The microcapsule display material, the binder, the plasticizer, and water are first mixed into a mixing solution and then microcapsulated or encapsulated. In one exemplary embodiment, in the mixing solution, a sum of contents of the microcapsule display material and the binder is 13 wt % and a content of water of 87%. Regarding the weights of the microcapsule display material, the binder, and water is totaled to be 100 wt %, the content of the plasticizer should account for 10 wt % to 60 wt % of the sum of weights of the microcapsule display material and the binder.

The absorption layer 16 is disposed above the microcapsule display layer 14. The absorption layer 16 absorbs light and can be referred as a light shielding layer which includes a plurality of pigments or dyes of a single color or multiple colors. The pigments or dyes can be blue, black, red, green, or other colors. The absorption layer 16 can be an unpatterned film. In other words, the absorption layer 16 of the present embodiment can cover the microcapsule display layer 14 entirely but is not limited thereto. The absorption layer 16 can also be a patterned film. A method of forming the patterned absorption layer 16 is, for example, an ink jet printing method. Forming the absorption layer 16 by the ink jet printing process allows the direct spray coating of a particular absorption material at a particular location, such that the absorption layer 16 obtains a particular pattern and a particular color after the ink jet printing process. However, the disclosure is not limited thereto. According to other embodiments, the patterned absorption layer 16 can also be formed through other printing processes, for example, a screen printing process.

The second electrode layer 20 is disposed above the microcapsule display layer 14. The second electrode layer 20 and the first electrode layer 12 are disposed relatively to drive the microcapsule display film 14 for the microcapsule display to display a particular image. In one exemplary embodiment, referring to FIG. 1, the second electrode layer 20 is disposed on the absorption layer 16. That is, the absorption layer 16 is disposed between the microcapsule display layer 14 and the second electrode layer 20. In another exemplary embodiment, referring to FIG. 2, the second electrode layer 20 is disposed between the microcapsule display layer 14 and the absorption layer 16. The second electrode layer 20 is a flexible transparent electrode. The second electrode layer 20 is an unpatterned electrode layer or a patterned electrode layer. The second electrode 20 and the first electrode 12 can be manufactured with the same or different material. In one exemplary embodiment, a material of the second electrode layer 20 includes a transparent conductive polymer, a conductive nanotube, an extendable transparent metal mesh, or a transparent conductive material, or a combination thereof. The transparent conductive polymer is PEDOT, PANI, PPY, or a combination thereof. The nanotube is a carbon nanotube (CNT), a silver nanowire, a gold nanowire, a copper nanowire, or an alloy nanowire. The extendable transparent metal mesh is manufactured with copper, silver, or gold, for instance. The transparent conductive material is a transparent conductive material such as graphene and so on. A method of forming the first electrode layer 12 is a wet coating method, a printing method, a thermal pressing method, an electro deposition method, a chemical deposition method, or a combination thereof.

A method of driving the microcapsule display film is a light-driven method, an electric driven method, a thermal writing/overwriting method, or other driving modes.

Moreover, the exemplary embodiment aforementioned is illustrated with an extendable display device having a first electrode and a second electrode. However, in another exemplary embodiment, referring to FIG. 3, an extendable display device of the disclosure may not include the first electrode and the second electrode. In other words, the extendable display device includes the extendable substrate 10, the microcapsule display film 14, and the absorption layer 16 and does not includes the first electrode and the second electrode. The microcapsule display film 14 is disposed between the extendable substrate 10 and the absorption layer 16. The microcapsule display film 14 includes a plasticizer, a binder, and a microcapsule display material. The composition and the ratio of the plasticizer, the binder, and the microcapsule display material are described above and not reiterated hereinafter.

### Examples 1 to 6

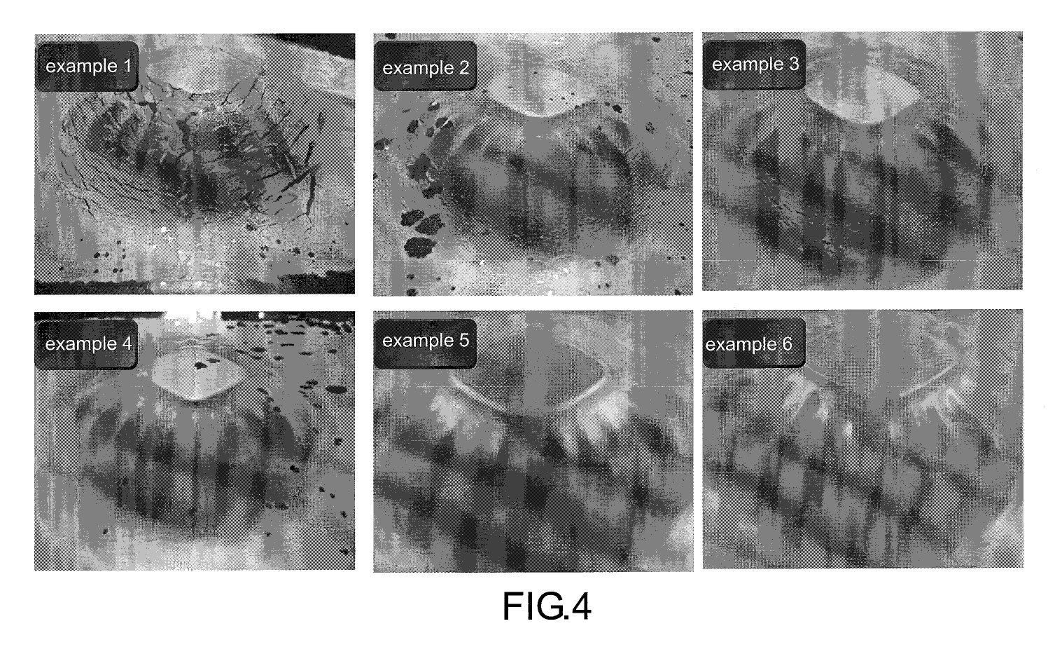

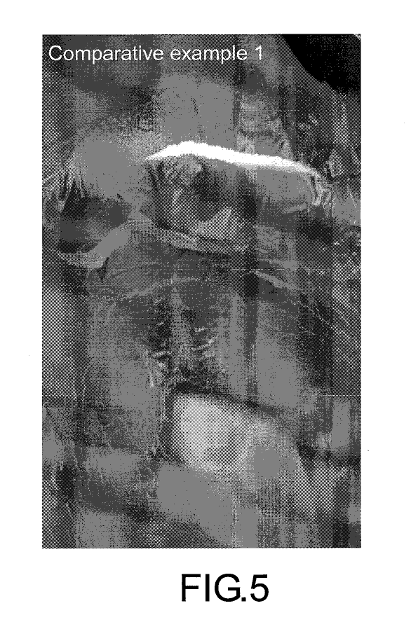

Referring to the weights depicted in Table 1, take the microcapsule cholesteric liquid crystal material and gelatin as the binder, and add water, plasticizer-glycerol to make a mixing solution. After manufacturing the mixing solution into a microcapsule cholesteric liquid crystal layer by a coil bar coating method and a natural drying method, a 120% tensile deformation is performed (that is, the deformation quantity is 20%) to form a tensile film as depicted in FIG. 4.

TABLE 1

| | Microcapsule | | | | |
|---|---|---|---|---|---|
| | cholesteric | | | | |
| | liquid crystal | Gelatin | Water | Glycerol | Fracture |
| | material (g) | (g) | (g) | (g) | level |
| Example 1 | 1.592 | 0.995 | 17.313 | 0.1 | Severe |
| Example 2 | 1.584 | 0.99 | 17.226 | 0.2 | Light |
| Example 3 | 1.576 | 0.985 | 17.139 | 0.3 | Very light |
| Example 4 | 1.568 | 0.98 | 17.052 | 0.4 | None |
| Example 5 | 1.56 | 0.975 | 16.965 | 0.5 | None |
| Example 6 | 1.52 | 0.95 | 16.53 | 1 | None |
| Comparative | 1.6 | 1 | 17.4 | 0 | Very |
| example 1 | | | | | severe |

### Comparative Example 1

Here, 1.6 g of the microcapsule cholesteric liquid crystal material, 1 g of gelatin as the binder, and 17.4 g of water are mixed to produce a mixing solution. After the microcapsule cholesteric liquid crystal layer is manufactured by a coil bar coating method and a natural drying method, a 120% tensile deformation is performed through a thermoforming method (that is, the deformation quantity is 20%) to form a tensile film as depicted in FIG. 5. As shown in FIG. 5, the microcapsule cholesteric liquid crystal layer with no glycerol added has very severe fractures after the 120% tensile deformation and has fractures even under a 105% tensile deformation. As depicted in FIG. 4, the fracture of the microcapsule cholesteric liquid crystal layer caused by the tensile deformation improves gradually with the increase of glycerol content. Additionally, a cholesteric liquid crystal display having the microcapsule cholesteric liquid crystal layer shown in examples 1 to 6 has no obvious increase in the driving voltage thereof and no obvious change in the display contrast.

### Examples 7 to 12

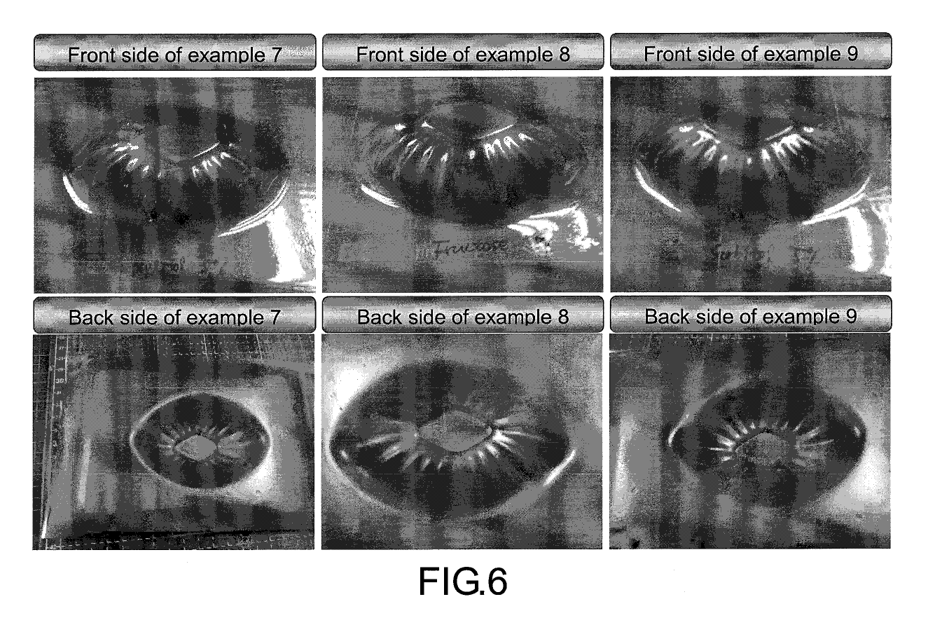

Here, 1.52 g of the microcapsule cholesteric liquid crystal material, 0.95 g of gelatin as the binder, and 16.53 g of water are mixed together. Different plasticizers are added to produce mixing solutions according to Table 2. After the microcapsule cholesteric liquid crystal layers are manufactured by a coil bar coating method and a natural drying method, a 120% tensile deformation is performed to form tensile films. FIG. 6 shows photos of front sides and back sides of the tensile films in examples 7-9.

TABLE 2

| | Microcapsule | | | | | | | | | |
|---|---|---|---|---|---|---|---|---|---|---|
| | cholesteric | | | | | | | | | |
| | liquid crystal | | | | | | | | | |
| | material | Gelatin | Water | Xylitol | Fructose | Sorbitol | Maltitol | Mannitol | Erythritol | Fracture |
| | (g) | (g) | (g) | (g) | (g) | (g) | (g) | (g) | (g) | level |
| Example 7 | 1.52 | 0.95 | 16.53 | 1 | 0 | 0 | 0 | 0 | 0 | None |
| Example 8 | 1.52 | 0.95 | 16.53 | 0 | 1 | 0 | 0 | 0 | 0 | None |
| Example 9 | 1.52 | 0.95 | 16.53 | 0 | 0 | 1 | 0 | 0 | 0 | None |
| Example | 1.52 | 0.95 | 16.53 | 0 | 0 | 0 | 1 | 0 | 0 | None |
| 10, | | | | | | | | | | |
| Example | 1.52 | 0.95 | 16.53 | 0 | 0 | 0 | 0 | 1 | 0 | None |
| 11 | | | | | | | | | | |
| Example | 1.52 | 0.95 | 16.53 | 0 | 0 | 0 | 0 | 0 | 1 | None |
| 12 | | | | | | | | | | |

Examples 7 to 12 in Table 2 show that when the plasticizer: xylitol, fructose, or sorbitol, maltitol, mannitol, or erythritol is added in the microcapsule cholesteric liquid crystal layer, no fracture is generated from the tensile deformation of the microcapsule cholesteric liquid crystal layer. Additionally, a cholesteric liquid crystal display having the microcapsule cholesteric liquid crystal layer shown in examples 7 to 12 has no obvious increase in the driving voltage thereof and no obvious change in the display contrast.

In summary, since the microcapsule cholesteric liquid crystal layer in the disclosure includes a plasticizer, the hydrophilic groups therein can absorb water or reduce the interaction between cholesteric liquid crystal molecules so as to enhance properties such as tensile and flexibility of the microcapsule cholesteric liquid crystal layer. Consequently, fractures of the microcapsule cholesteric liquid crystal layer resulting from tension or bending can be can be reduced for the microcapsule cholesteric liquid crystal layer to be applied in the tensile display.

It will be apparent to those skilled in the art that various modifications and variations can be made to the structure of the disclosed embodiments without departing from the scope or spirit of the disclosure. In view of the foregoing, it is intended that the disclosure cover modifications and variations of this disclosure provided they fall within the scope of the following claims and their equivalents.

What is claimed is:

1. An extendable display device, comprising:
an extendable substrate; and
a microcapsule display film disposed on the extendable substrate and comprising a plasticizer and a microcapsule display material.

2. The extendable display device as claimed in claim 1, wherein the plasticizer comprises polyhydric alcohol, a derivative of polyhydric alcohol, polyol, or a combination thereof.

3. The extendable display device as claimed in claim 2, wherein the polyhydric alcohol comprises sorbitol, xylitol, fructose, amylose, maltitol, mannitol, erythritol or a combination thereof.

4. The extendable display device as claimed in claim 2, wherein the polyol comprises ethylene glycol, propylene glycol, glycerin, butylene glycol, butanetriol, polyethylene glycol, or a combination of structural isomers thereof.

5. The extendable display device as claimed in claim 1, wherein the microcapsule display film further comprises a binder.

6. The extendable display device as claimed in claim 5, wherein a content of the plasticizer in the microcapsule display film ranges from 10% by weight-60% by weight with a sum of weights of the microcapsule display material and the binder in the microcapsule display film being 100%.

7. The extendable display device as claimed in claim 5, wherein the binder comprises polyvinylalcohol, animal glue, vegetable gum, microbial gum, or a combination thereof.

8. The extendable display device as claimed in claim 1, wherein the microcapsule display material comprises a cholesteric liquid crystal or an electrophoretic microparticle.

9. The extendable display device as claimed in claim 1, further comprising:
a first electrode disposed between the extendable substrate and the microcapsule display film; and
a second electrode disposed on the microcapsule display film.

10. The extendable display device as claimed in claim 9, wherein the first electrode and the second electrode are each a flexible transparent electrode.

11. The extendable display device as claimed in claim 10, wherein the flexible transparent electrode comprises a transparent conductive polymer, a conductive nanotube, an extendable transparent metal mesh, or a transparent conductive material, or a combination thereof.

12. The extendable display device as claimed in claim 1, wherein a method of driving the microcapsule display film comprises a light-driven method, an electric driven method, or a thermal writing/overwriting method.

13. The extendable display device as claimed in claim 1, wherein the extendable substrate comprises a thermoplastic polymer substrate or an elastic polymer substrate.

14. The extendable display device as claimed in claim 9, further comprising an absorption layer disposed on the microcapsule display film.

15. The extendable display device as claimed in claim 14, wherein the absorption layer comprises a plurality of pigments or dyes of a single color or multiple colors.

16. The extendable display device as claimed in claim 1, further comprising an absorption layer disposed on the microcapsule display film.

17. The extendable display device as claimed in claim 16, wherein the absorption layer comprises a plurality of pigments or dyes of a single color or multiple colors.

18. The extendable display device as claimed in claim 16, wherein the absorption layer is disposed between the microcapsule display film and the second electrode, or the second electrode is disposed between the microcapsule display film and the absorption layer.
